(19) United States
(12) Patent Application Publication
(10) Pub. No.: US 2008/0013021 A1
(43) Pub. Date: Jan. 17, 2008

(54) Cellular telephone and personal viewing mirror combination

(76) Inventor: Eleni E. Gugliotta, Richfield, OH (US)

Correspondence Address: PATENT, COPYRIGHT & TRADEMARK LAW GROUP, PO BOX 506, RICHFIELD, OH, 44286, US

(21) Appl. No.: 11/293,756

(22) Filed: Dec. 5, 2005

Related U.S. Application Data
(60) Provisional application No. 60/635,082, filed on Dec. 10, 2004.

(51) Int. Cl. G02F 1/1335

(52) U.S. Cl. 349/113

(57) ABSTRACT

An improvement to an otherwise conventional cellular telephone is provided in which a one-way mirror, sometimes referred to as a ‘half-silvered’ mirror, is place directly over the outer LCD screen surface. This one-way mirror reflects only some of the incident light back as reflected, and when the LCD is powered the light transmitted overtakes the intensity of the reflected image, and the screen appears as a conventional LCD screen. However, with the screen off and no light transmitted, the reflected light prevails and the incident image can be clearly seen with enough utility for purposes of checking or maintaining one's appearance while on the run.

### RELATED APPLICATIONS

The present invention claims the benefit of U.S. Provisional Patent Application 60/635,082, filed Dec. 12, 2004 and incorporated by reference as if fully rewritten herein.

### BACKGROUND OF THE INVENTION

1. Field of the Invention

The present invention relates generally to cellular telephones and, more particularly, to a cellular telephone combined with other personal care devices normally carried separately.

2. Description of the Related Art

In recent years, the development of cellular telephony has led to devices that are more compact than ever before. In fact, in addition to the other increases in the number and type of functional features, cellular telephones today are readily available of a size that can be easily transported in a pocket, clipped to a belt, or carried in a bag or purse. For many of those individuals who are fashion, trend, or style conscious enough to have such a conveniently carried cellular telephone, a similar sense of fashion, or style would likely lead the same individual to carry other accessories, such as a brush or comb, makeup, or a mirror. Further, these other grooming devices or accessories would likely be carried in the same purse or bag as the cellular telephone.

A “compact” holds makeup or cosmetics, such as powders, creams, lotions, eye shadow, lipstick, eyeliner, or other beauty aides. Makeup is available in a large variety of colors and textures. Compacts often provide a mirror to allow the users to view themselves as they apply makeup to their face. A compact includes a lid section and a container section linked together by a hinge. The lid section and container section may be closed upon each other about the hinge so that the compact provides a convenient storage device. A mirror is generally located on the underside of the lid section.

However, many times a “compact” is not compact enough, or the makeup contained therein is not the type needed or desired, or maybe a user merely wants to access the mirror portion. And, generally speaking, many would find it desirable to have a portable mirror available to them on many occasions, but at far fewer times do they find themselves carrying such a portable device on the chance arising of such a need. In such cases, having a mirror available in combination with one's cellular telephone would be helpful.

A search of the prior art did not disclose any patents that read directly on the claims of the instant invention; however, the following references were considered related:

| U.S. Pat. No. | Inventor | Issue Date |
|---|---|---|
| 5,940,229 | Baumgarten | Aug. 17, 1999 |
| 4,033,672 | Dalmasso | Jul. 5, 1977 |
| 4,623,222 | Itoh et al. | Nov. 18, 1986 |
| 6,825,895 | Nakano et al. | Nov. 30, 2004 |

Consequently, a need has been felt for providing a mirror image reflecting surface in conjunction with an otherwise conventional cellular telephone.

### SUMMARY OF THE INVENTION

It is therefore an object of the present invention to provide an otherwise conventional telephone incorporating a mirror reflecting surface.

It is a feature of the present invention to provide an otherwise conventional cellular telephone improved by incorporating a semi-reflective surface atop the telephones LCD display screen, thereby providing an otherwise conventional ‘mirror’ surface when the LCD display screen is un-lit.

Briefly described according to one embodiment of the present invention, an improvement to an otherwise conventional cellular telephone is provided in which a one-way mirror, sometimes referred to as a ‘half-silvered’ mirror, is place directly over the outer LCD screen surface. This one-way mirror reflects only some of the incident light back as reflected, and when the LCD is powered the light transmitted overtakes the intensity of the reflected image, and the screen appears as a conventional LCD screen. However, with the screen off and no light transmitted, the reflected light prevails and the incident image can be clearly seen with enough utility for purposes of checking or maintaining one's appearance while on the run.

Further, additional features, such as an external LED or other illumination source can be provided for improving the lighting of the user's face while using the mirror.

An advantage of the present invention is a mirror can be provided in combination with any cellular telephone.

Another advantage of the present invention is that it can provide such a feature with little additional cost to the cellular telephone.

Yet another advantage of the present invention is that it can provide such a feature without deterring from or competing with other features offered for use with a cellular telephone.

Further, an illumination means can be further provided to improve lighting of the user's face while using the mirror.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 is a perspective view of an otherwise conventional cellular telephone according to the PRIOR ART;

FIG. 2 is a perspective view of a cellular telephone and personal view mirror combination according to the present invention;

FIG. 3A is a cross sectional view of a liquid crystal LCD display according to the preferred embodiment of the present invention;

FIG. 3B through FIG. 3E are cross sectional views of liquid crystal displays according to alternate embodiments of the present invention;

FIG. 4 is a perspective view of a cellular telephone, personal view mirror and illumination means combination according to an alternate embodiment of the present invention; and

FIG. 5 is a schematic illustrating one alternate method of alternating power between an LCD and illumination means.

### DESCRIPTION OF THE PREFERRED EMBODIMENTS

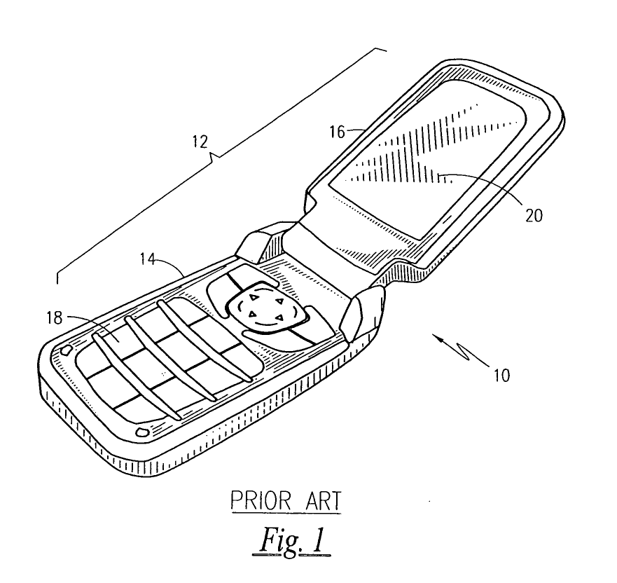

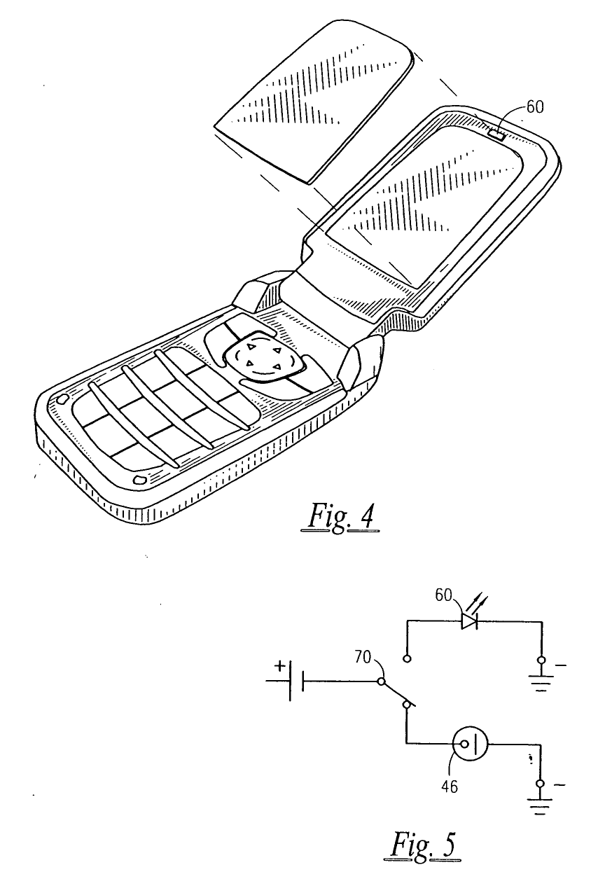

The best mode for carrying out the invention is presented in terms of its preferred embodiment, herein depicted within the FIGS. 1-5.

1. Detailed Description of the Figures

Referring first to FIG. 1, an otherwise conventional cellular telephone 10 is shown according to the prior art. For purpose example, and not meant in any form as a limitation, the telephone 10 is based upon a Sanyo model 8200 camera phone in which a clamshell housing 12 has a lower housing portion 14 pivotally affixed to an upper housing portion 16. The lower housing portion 14 forms access to the control input means, shown herein as a keyboard 18. The lower housing portion 14 also contains the telephony electronics. The upper housing portion 16 retains and contains a display means 20, herein shown as a liquid crystal display (LCD).

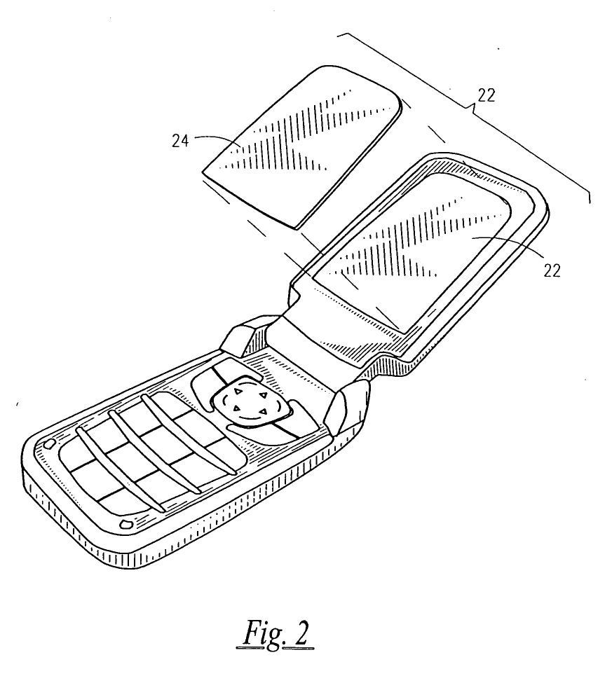

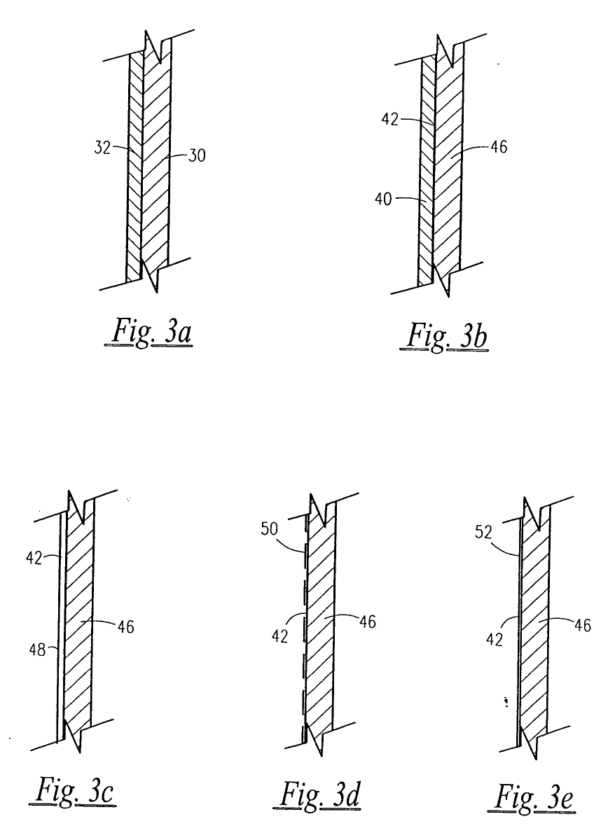

Referring now to FIG. 2, a combination cellular telephone and personal viewing mirror 22 is shown embodying the teachings of the present invention, in which a display means 24 forms a liquid crystal display having a partially reflective outer surface 24. As shown in conjunction with FIG. 3a, it is envisioned that the display 24 comprises an otherwise conventional liquid crystal display portion 30 having a semi-reflective outer surface 32 which is capable of reflecting enough incident light when the LCD is not transmitting to reflect the incident image. It is anticipated that transmittance between 30% and 70% will suffice, depending upon the brightness of the LCD output. Further, as shown in conjunction with FIG. 3b-3e, it is anticipated that the objects and features of the present invention can be obtained by applying a semi-mirrored, or on-way mirror panel 40 directly over the outer surface 42 of an LCD screen 46, by layering a semi-mirrored or semi-silvered film 48 onto the outer surface 42 of an LCD screen 46, by depositing 50 a partial covering of a reflective molecule 50, such as aluminum, onto the outer surface 42 of an LCD screen, or by coating sparse coating of a reflective substance 52 onto the outer surface 42 of an LCD screen.

Additionally, an illumination means 60, such as a light emitting diode, can be provided to allow for better lighting of the users face in poorly lit environments to assist the semi-reflective surface to appear to the onlooker as a mirror, which will happen when the incident light external to the outer surface is of a sufficient density that the light reflected back from the transmissive surface exceeds the intensity of any light that may be being transmitted through the LCD screen.

Finally, referring now to FIG. 5 an alternate embodiment is shown and described in which the lighting feature and mirror feature are integrated such that a manual switching means 70, such as a command generated from a series of keystroke entries, or a separate, dedicated button available on the housing is used to initiate switching the LCD display to the “off” position while simultaneously, or subsequently powering the illumination LED. Such functionality would insure that external light intensity would exceed transmitted light and thereby assure that the viewer would obtain a clear, usable mirror surface for viewing.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents. Therefore, the scope of the invention is to be limited only by the following claims.

What is claimed is:

1. In combination:
an otherwise conventional cellular telephone having a display means formed of a liquid crystal display (LCD) having an outer surface; and
a personal viewing mirror integrated to said outer surface.

2. The combination of claim 1, wherein said personal viewing mirror is formed by said liquid crystal display having a semi-reflective outer surface which is capable of reflecting enough incident light when said LCD is not transmitting to reflect the incident image.

3. The combination of claim 2, wherein said semi-reflective outer surface has a transmittance between 30% and 70%.

4. In an otherwise conventional cellular telephone in which a liquid crystal display is used as a display means, the improvement comprising:
applying a semi-mirrored or one-way mirror panel directly over an outer surface of said LCD screen such as to form a personal viewing mirror when said LCD is not illuminated.

5. In the otherwise conventional cellular telephone of claim 4, the improvement further comprising layering a semi-mirrored or semi-silvered film onto an outer surface of said LCD screen such as to form a personal viewing mirror when said LCD is not illuminated.

6. In the otherwise conventional cellular telephone of claim 4, the improvement further comprising depositing a partial covering of a reflective molecule onto an outer surface said LCD screen such as to form a personal viewing mirror when said LCD is not illuminated.

7. In the otherwise conventional cellular telephone of claim 4, the improvement further comprising coating a sparse coating of a reflective substance onto an outer surface of said LCD screen such as to form a personal viewing mirror when said LCD is not illuminated.

8. The combination of claim 2, further comprising:
illumination means to allow for better lighting of the users face in poorly lit environments.

9. The combination of claim 8, wherein said illumination means comprises a light emitting diode.

10. The combination of claim 9, further comprising:
manual switching means to initiate switching said LCD display to the “off” position while simultaneously, or subsequently powering said illumination LED.

11. In the otherwise conventional cellular telephone of claim 4, the improvement further comprising illumination means to allow for better lighting of the users face in poorly lit environments.

12. The improvement of claim 11, wherein said illumination means comprises a light emitting diode.

13. A method for providing a personal viewing mirror, said method comprising the steps:
a. Obtaining a cellular telephone having a display means formed of a liquid crystal display (LCD) having an outer surface; and
b. Forming a semi-reflective outer surface onto said LCD which is capable of reflecting enough incident light when said LCD is not transmitting to reflect the incident image.

14. The method of claim 13, further comprising the steps:
a. Forming said semi-reflective outer surface to a transmittance of between 30% and 70%.

15. In the method of claim 13, wherein said semi-reflective outer surface is formed by applying a semi-mirrored or one-way mirror panel directly over said outer surface of said LCD screen.

16. In the method of claim 13, wherein said semi-reflective outer surface is formed by layering a semi-mirrored or semi-silvered film onto an outer surface of said LCD screen.

17. In the method of claim 13, wherein said semi-reflective outer surface is formed by depositing a partial covering of a reflective molecule onto an outer surface said LCD screen.

18. In the method of claim 13, wherein said semi-reflective outer surface is formed by coating a sparse coating of a reflective substance onto an outer surface of said LCD screen.

19. In the method of claim 13, wherein said cellular telephone further has illumination means to allow for better lighting of the users face in poorly lit environments.

20. In the method of claim 19, wherein said said illumination means comprises a light emitting diode.
